(19) United States
(12) Patent Application Publication
(10) Pub. No.: US 2012/0018016 A1
(43) Pub. Date: Jan. 26, 2012

(54) BASIN FLUSHING SYSTEM

(76) Inventors: Robin Gibson, Camas, WA (US); James M. Tillman, Washougal, WA (US)

(21) Appl. No.: 13/038,364

(22) Filed: Mar. 1, 2011

Related U.S. Application Data
(60) Provisional application No. 61/309,402, filed on Mar. 1, 2010.

(51) Int. Cl. F03B 11/02

(52) U.S. Cl. 137/561 R

(57) ABSTRACT

A flushing apparatus includes a nozzle block having a first interior channel, a first low angle nozzle group, a second medium angle nozzle group; an extension portion mountable through a basin wall, and including a second interior channel connectable to a flushing water source extending to the nozzle block interior channel and a sidewall penetration for receiving a tube into the second interior channel; and a tube extending from a water source, passing through the penetration into the second internal channel and said first internal channel, and extending through the nozzle head to a second end connectable to a fountain discharge head. The low angle nozzle discharges are in the range 0 to 10 degrees and the medium angle nozzle discharges are in the range 10 to 30 degrees. A basin water return may extend through the nozzle block and extension portion to a recirculation pump.

### CROSS REFERENCE TO RELATED APPLICATIONS

This application is a nonprovisional application of, and claims priority to, U.S. Provisional Application Ser. No. 61/309,402, filed Mar. 1, 2010, which is hereby incorporated by reference into this application.

### FIELD OF THE INVENTION

The present invention relates to flushing systems for fountain and bird bath basins.

### BACKGROUND

Small decorative fountains, bird baths and other small water features are popular aesthetic design additions to homes, courtyards and public spaces. Bird baths generally are shallow basins holding static water. Fountains generally include a small basin, a recirculation pump drawing water from the basin and discharging the water through a fountain head or heads back into the basin, often via cascading layers. The basin often includes a rounded bowl with a generally concave spherical inner surface, which may or may not include a low point drain to feed into a recirculation pump or may simply overflow into another collection basin. The relatively stagnant water in the bowl can quickly become fouled with growth and sediment buildup without periodic flushing, even in a recirculation fountain.

Regular flushing by water impinging on the bowl interior surfaces will significantly improve the cleanliness of the water feature, but it is not cost effective to install complicated systems with large numbers of moving parts requiring maintenance, or with parts which require design changes in the bath or fountain to preserve the aesthetic look of the water feature. Systems with mechanical arms, for instance, are ungainly, prone to breakdown, and could potentially injure birds or wildlife attracted to the water feature. Moreover, most small fountains used in private residences and yards provide only a single penetration through the bottom of the basin for connecting a fountain water source—frequently a small pump which recirculates water from the basin, but which may be an external source—to the fountain discharge head which directs the water outward for display. Thus, there is often no discrete way to run a second source of high velocity flush water into the fountain basin. The fountain discharge head may include decorative shapes and may comprise an infinite variety of spray patterns. Additionally, the flushing system should include a setting that is relatively unobtrusive during operation such that wildlife won't become scared of the water feature and people nearby won't be bothered by the flushing system.

Thus, there is a need for a flushing system which can be retrofitted to existing water features, which is reliable and robust, which includes a minimum number of moving parts and minimal maintenance, and which does not interfere with the use of the water feature during operation, which won't harm wildlife or bother people nearby.

### SUMMARY AND ADVANTAGES

A flushing apparatus mountable to a water feature having a basin wall defining a basin and a mounting hole through the basin wall, includes a nozzle block having a first interior channel, a first nozzle group having a plurality of low angle nozzles distributed along the perimeter of the nozzle block and in fluid communication with the interior channel, a second nozzle group having a plurality of medium angle nozzles distributed along the perimeter of the nozzle block and in fluid communication with the interior channel; and, an extension portion mountable through the mounting hole, the extension portion including a second interior channel connectable between a flushing water source at a first end and the nozzle block interior channel at a second end. An apparatus may include wherein the extension portion further includes a penetration for sealinglly receiving a tube into the second interior channel; a tube, the extending from a first end connectable to a fountain discharge water source, passing through the penetration into the second internal channel and the first internal channel, and extending through the nozzle head to a second end connectable to a fountain discharge head. An apparatus may include wherein the first nozzle group includes at least three nozzles distributed around the perimeter of the nozzle block at equal intervals. An apparatus may include wherein each of the first nozzle group plurality of low angle nozzles has a discharge angle in the range 0 to 10 degrees above horizontal. An apparatus may include wherein each of the low angle nozzles has a discharge angle of approximately 5 degrees above horizontal. An apparatus may include wherein the second nozzle group includes at least three nozzles distributed around the perimeter of the nozzle block at equal intervals. An apparatus may include wherein each of the second nozzle group plurality of medium angle nozzles has a discharge angle in the range 10 to 30 degrees above horizontal. An apparatus may include a basin water return extending from a first end in fluid communication with the basin, through the nozzle block and the extension portion, to a second end connectable to a fountain recirculation pump intake. An apparatus may include a solenoid valve disposed between the flushing water source and the extension portion first end; and, a controller in control communication with the solenoid valve.

The flushing apparatus of the present invention presents numerous advantages, including: (1) prevents unsightly or unsanitary conditions from building up in water features such as fountains and bird baths; (2) utilizes a minimum of moving parts; (3) is compatible with the vast majority of bird bath basin designs; (4) avoids or minimizes the use of chemical cleaners through regular cycling; (5) provides the ability to apply automatic controls; (6) can be integrated into a common automatic lawn sprinkler system.

Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows a cutaway side view of an embodiment of a fountain flushing system installed in a fountain basin.

FIG. 2 shows a bottom view of an embodiment of a fountain flushing system installed in a fountain basin.

FIG. 3 shows a top perspective view of an embodiment of a fountain flushing system installed in a fountain basin, with the system activated.

FIG. 4 shows a partial cutaway side view of an embodiment of a flushing system installed in a fountain basin.

FIG. 5 shows a partial cutaway side view of an embodiment of a flushing system installed in a fountain basin.

FIG. 6 shows a side view of a nozzle block of an embodiment of a flushing system.

FIG. 7 shows a cutaway side view of a nozzle block of an embodiment of a flushing system.

FIG. 8 shows a top view of a nozzle block of an embodiment of a flushing system.

FIG. 9 shows a cutaway side view of a nozzle block of an embodiment of a flushing system

FIG. 10 shows a cutaway side view of a nozzle block of an embodiment of a flushing system.

FIG. 11 shows a cutaway side view of a second embodiment of a flushing system.

### DRAWING REFERENCE NUMBERS

The following list of drawing reference numbers is provided for convenience only:

| | |
|---|---|
| 10 | First embodiment |
| 20 | Extension portion |
| 30 | Nozzle block |
| 40 | Extension portion first end |
| 50 | Extension portion second end |
| 60 | Second internal channel |
| 70 | Low angle nozzles |
| 70A | Low angle nozzle water flow |
| 80 | First internal channel |
| 90 | Nozzle block pass through |
| 100 | |
| 110 | Tube |
| 120 | Tube first end |
| 130 | Fountain water source |
| 140 | Tube second end |
| 150 | Extension portion internal channel sidewall |
| 160 | Fountain discharge head |
| 170 | Sidewall penetration |
| 180 | Medium angle nozzles |
| 180A | Medium angle nozzle flow |
| 190 | Tubing anchor |
| 220 | Basin mounting hole |
| 230 | Nozzle block perimeter |
| 1010 | Second embodiment |
| 1020 | Extension portion |
| 1030 | Nozzle block |
| 1040 | Extension portion first end |
| 1060 | Extension portion internal channel |
| 1110 | Tube |
| 1170 | Sidewall penetration |
| 1240 | Fountain water return |
| 1250 | Return first end |
| 1260 | Return second end |
| 1270 | Automatic valve |
| 1280 | Valve timer controller |
| 1290 | Return penetration fitting |
| B | Basin |
| W | Basin wall |
| DW | Domestic water supply |
| P | Recirculation pump |
| R | Recirculation reservoir |

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

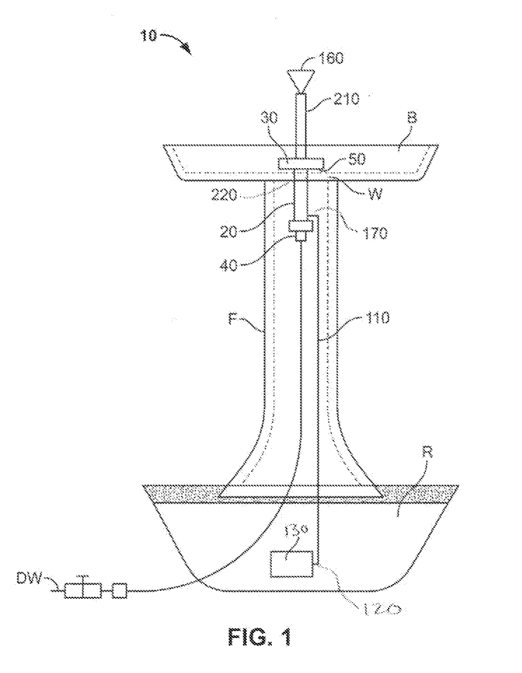

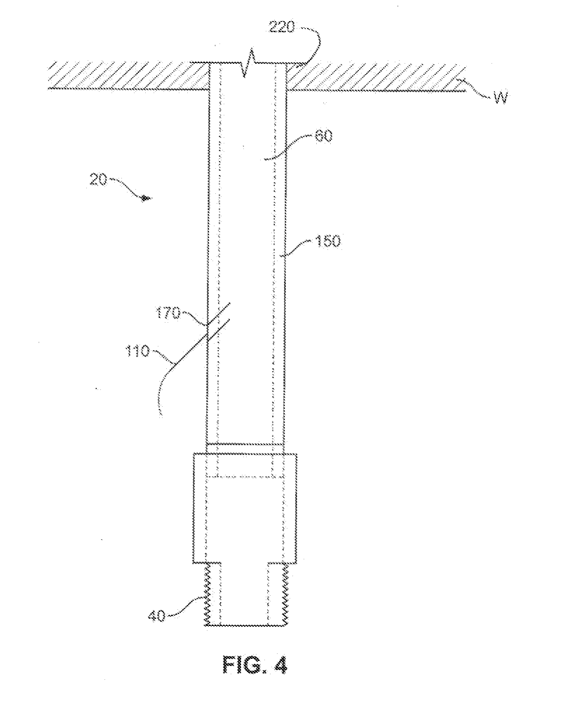

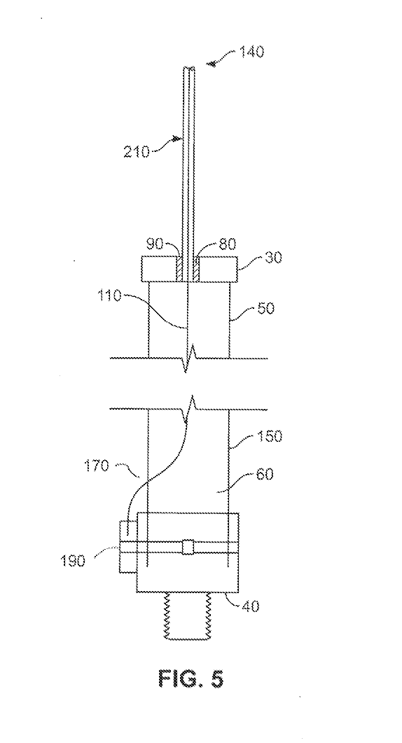

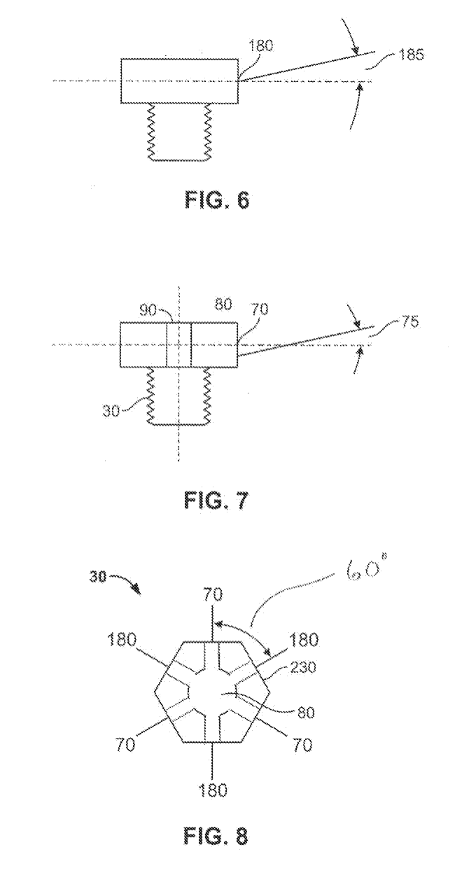

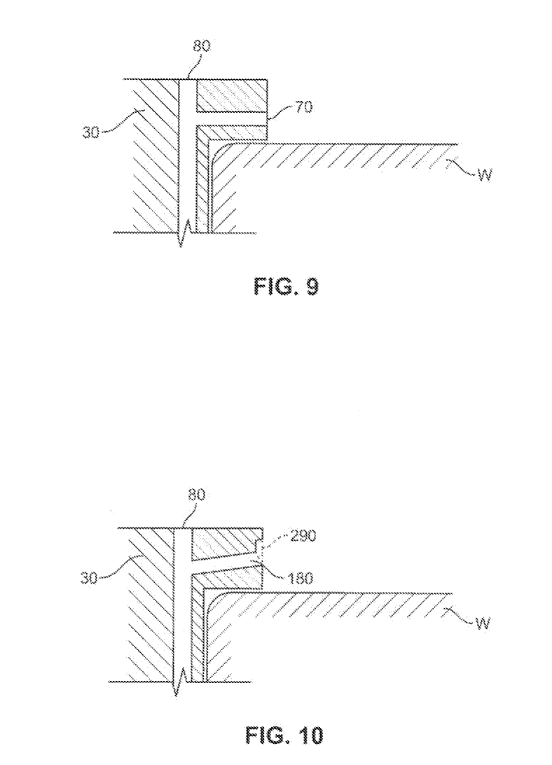

Referring to FIGS. 1-10, a first embodiment of a flushing apparatus 10 mountable to a water feature F having a basin wall W defining a basin B and a mounting hole 220 through the basin wall W is shown, and includes a nozzle block 30 having a first interior channel 80, a first nozzle group having a plurality of low angle nozzles 70 distributed along the perimeter 230 of nozzle block 30 in fluid communication with interior channel 80, a second nozzle group having a plurality of medium angle nozzles 180 distributed along the perimeter 230 of nozzle block 30 In fluid communication with interior channel 80; and, an extension portion 20 mountable through mounting hole 220, extension portion 20 including a second interior channel 60 connectable between a flushing water source at a first end 40 and nozzle block interior channel 80 at a second end 50.

In the embodiment, apparatus 10 includes wherein extension portion 20 further includes a penetration 170 for sealinglly receiving tube 110 into second interior channel 60, with tube 110 extending from a first end 120 connectable to a fountain discharge water source 130, passing through penetration 170 into second internal channel 60 and first internal channel 80, and extending through nozzle block 30 to a second end 140 connectable to a fountain discharge head 160.

In the embodiment, first low angle nozzle group includes at least three nozzles 70 distributed around the perimeter 230 of nozzle block 30 at equal intervals, and each of low angle nozzles 70 has a discharge angle 75 in the range of 0 to 10 degrees above horizontal, and in this embodiment the angle is approximately 5 degrees.

In the embodiment, a second medium angle nozzle group includes at least three nozzles 180 distributed around the perimeter 230 of nozzle block 30 at equal intervals, and each of medium angle nozzles 180 has a discharge angle 185 in the range of 10 to 30 degrees above horizontal, and in this embodiment the angle is approximately 30 degrees.

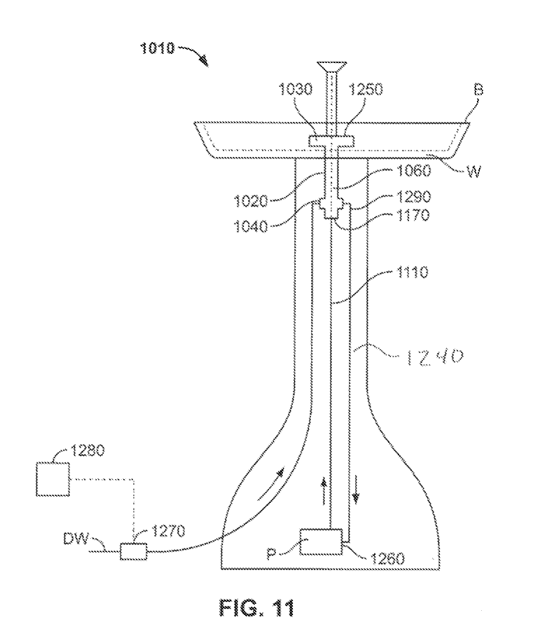

Referring to FIG. 11, a second embodiment 1010 is shown including a basin water return 1240 extending from a first end 1250 in fluid communication with basin B, through nozzle block 1030 and extension portion 1020, out of extension portion 1020 through fitting 1290, and to a second end 1260 connectable to a fountain recirculation pump P intake. Fountain water discharge tube 1110 penetrates into extension portion 1020 interior channel 1160 through penetration 1170 at an end wall of a tee fitting. Domestic water DW connects at extension portion first end 1040.

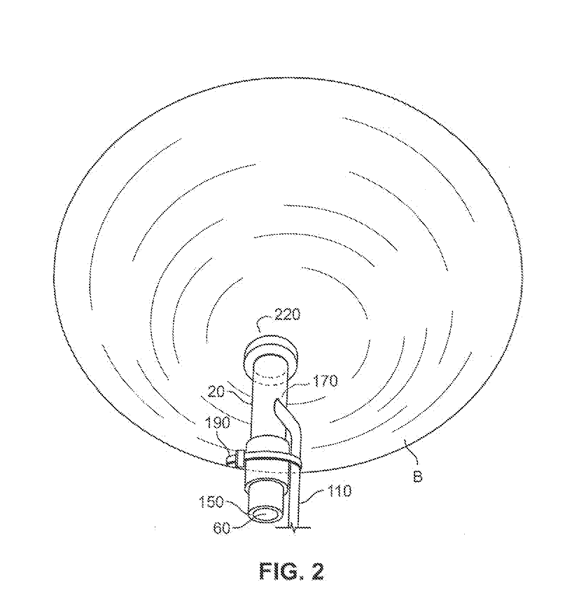

Referring again to FIGS. 1, 2 & 4-5, extension portion 20 is mountable through basin wall W at mounting hole 220. In the first embodiment, extension portion 20 is a short pipe 25 having a first end 40 connectable to a flushing water source, in this case a domestic water connection DW, a second end 50 coupled to nozzle block 30, with interior channel 60 in fluid communication with first end 40 and second end 50 and nozzle block interior channel 80.

Tube 110 provides fountain discharge water for aesthetics, passing through nozzle block 30 and copper extension piece 210, which is rigid to support fountain discharge fixture 160. Fountain discharge water tube 110 enters interior channel 60 through sealed penetration 170 in pipe sidewall 150, extends through a portion of interior channel 60, and passes through nozzle block 30 via internal channel 80, threaded coupling 90, and copper tube 210 to connect at its second end 140 with a fountain discharge 160. In the embodiment a ZipTie® anchor 190 retains tube 110 to extension portion 20 to prevent bouncing from water pressure changes or inadvertent contact.

In the embodiment, fountain water tube 110 is a small diameter flexible tube of ¼ inch (6 mm) diameter coupled at a first end 130 to the discharge of a small fountain recirculation pump (using commonly available or easily produced adaptors, as necessary) and at a second end 140 to the fountain discharge head 160. Fountain discharge head 160 is mounted in elevated from basin B using a copper tube extension 210 which couples to nozzle block 30 through internal passage 80 using threaded compression connectors 90 which seal snuggly around tube 110, and fountain water tube 110 extends all the way through copper tube 210 to connect directly to discharge head 160. Some leakage may occur through connectors 90 without causing problems. If better sealing is desired, tube 110 could terminate tube end 140 into threaded connector 90, and an extension extend from threaded connector 90 up to discharge head 160.

Fountain discharge water tube 110 passing through nozzle block 30 allows a fountain to be supplied with fountain water and flushing water through a single penetration 220 in basin wall W, which is sealed using known methods. This single penetration system permits construction of simpler, less expensive basins, and allows the system to be retrofitted to existing basins with single penetrations.

A separate flush water source is provided for flushing in order to supply clean water at higher pressure—and therefore higher velocity—and flow rates than most fountain recirculation pumps are able to provide. In the embodiment, tube first end 40 is coupled to a ½ inch (12.7 mm) flexible tube, which is in turn coupled to a standard ¾ inch (20 mm) garden hose connectable to domestic water line pressure. Interior channel 60 is isolated from fountain discharge water tube 110, so it may be left uncoupled to a water source during non-use without draining the fountain.

Alternatively, it may be left permanently coupled to a flush water source and controlled by valve 1270. Referring to FIG. 11, the second embodiment provides an automatic solenoid valve 1270 controlled electronically by timer 1280. By way of example, valve 1270 could be a valve in the valve manifold of a domestic automatic sprinkler system including a timer 1280 to provide regular flushing.

The fountain discharge water supply may continue to operate without interruption during a flushing cycle, or may be off. The basin B may be already filled with water or initially empty, with the flushing water source supplying sufficient water to overflow the basin B and carry out the sediment and growth stripped from the basin surfaces. In the Specification and Claims, basin B is assumed to be mounted approximately level, such that the “horizontal” plane is essentially synonymous with the bottom plane or bottom tangent plane of basin B, depending on if the bottom of basin B is flat or concave.

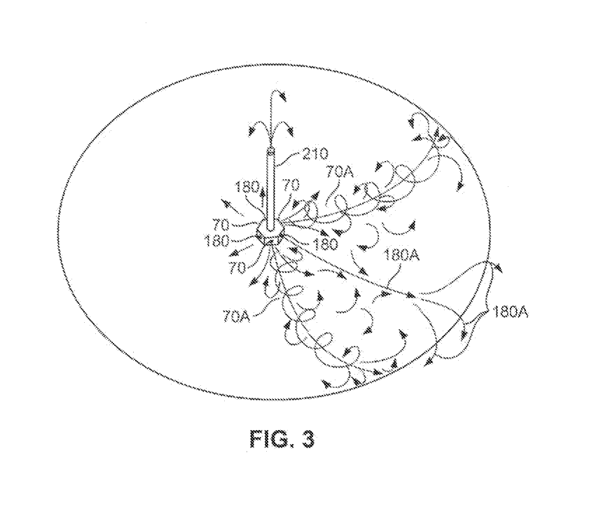

Referring to FIG. 3, the flushing operation is shown (not all nozzles are shown). The flushing apparatus includes two nozzle groups: a first group having a plurality of nozzles 70 at a low discharge angle mounted proximal to the bottom surface of basin B, and a second group having a plurality of nozzles 180 at a higher discharge angle relative to the first group mounted proximal to the bottom surface of basin B. In operation, the first nozzle group 70, which is oriented at a slight angle above horizontal, scours the interior surfaces of basin B, as indicated by water flow arrows labeled 70A. Providing a discharge angle slightly above horizontal creates sufficient turbulence along the bottom and sidewall surfaces of basin B to dislodge sediment and growth and creates a slight upwelling that brings the debris toward the water surface. The high velocity water flow 70A spreads out as it moves away from the nozzles 70 effectively agitating the entire bottom surface of basin B. The second nozzle group 180, having a discharge angle greater than the first group, entrains the water and debris lifted by the first nozzle group 70 and pushes this debris over the side of basin B to expel it by overflowing, as indicated by water flow 180A.

The specific nozzle discharge angles have been determined by the inventors through experimentation with a range of basin diameters and depth profiles. Regarding the second nozzle group, a discharge angle approximately 10° above horizontal is sufficient for shallow, small diameter basins (approximately up to 16 inches (40 cm)). Shallower basins, basins with sidewalls which are more flat (i.e. flare outwards farther from vertical), and basins with smaller diameters require lower discharge angles. As basin depth increases, basin sidewalls become more vertical, or basin diameter increases, a greater discharge angle is desirable. A discharge angle of 30° above horizontal was found to be the maximum desirable angle for common basin sizes, up to approximately 2 feet (61 cm) diameter.

With flushing water tube 150 coupled to a flushing water supply at typical domestic water pressure (approximately 40 psig), the flushing apparatus will entrain so much water from the basin that the basin may be almost completely evacuated.

The shape of nozzle block 30 and the number and arrangement of flush nozzles 70 and 180 may be varied to account for different shaped basins (e.g. square shaped basins) to ensure even coverage. The inventors have found that a first nozzle group of three nozzles 70 disposed at 120° intervals, alternating with a second nozzle group of three nozzles 180 disposed at 120° intervals, provides adequate cleaning for most common basin shapes and sizes. Larger basins may require a greater number of nozzles. In the embodiment, nozzles 70 and 180 are straight bore nozzles with no diverging discharge. In the embodiment, first nozzle group nozzles 70 have a 1/16 inch (1.5 mm) bore and second nozzle group nozzles 180 have a 0.0758 inch (1.994 mm) bore, corresponding to a #47 drill bit. In the embodiment, second nozzle group nozzles 180 are spot face drilled 290 to provide a surface normal to the nozzle bore axis so that the nozzle discharge cross-section remains circular rather than distorted to an oval, which produces a more stable discharge stream and more efficient removal of debris.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. A flushing apparatus mountable to a water feature having a basin wall defining a basin and a mounting hole through said basin wall, said apparatus comprising:
a nozzle block having a first interior channel, a first nozzle group having a plurality of low angle nozzles distributed along the perimeter of said nozzle block and in fluid communication with said interior channel, a second nozzle group having a plurality of medium angle nozzles distributed along the perimeter of said nozzle block and in fluid communication with said interior channel; and,
an extension portion mountable through said mounting hole, said extension portion including a second interior channel connectable between a flushing water source at a first end and said nozzle block interior channel at a second end.

2. The apparatus of claim 1, further comprising:
wherein said extension portion further includes a penetration for sealinglly receiving a tube into said second interior channel;
a tube, said extending from a first end connectable to a fountain discharge water source, passing through said penetration into said second internal channel and said first internal channel, and extending through said nozzle head to a second end connectable to a fountain discharge head.

3. The apparatus of claim 1 or 2, further comprising:
wherein said first nozzle group includes at least three nozzles distributed around the perimeter of said nozzle block at equal intervals.

4. The apparatus of claim 3, further comprising:
wherein each of said first nozzle group plurality of low angle nozzles has a discharge angle in the range 0 to 10 degrees above horizontal.

5. The apparatus of claim 4, further comprising:
wherein each of said low angle nozzles has a discharge angle of approximately 5 degrees above horizontal.

6. The apparatus of claim 1 or 2, further comprising:
Wherein said second nozzle group includes at least three nozzles distributed around the perimeter of said nozzle block at equal intervals.

7. The apparatus of claim 6, further comprising:
wherein each of said second nozzle group plurality of medium angle nozzles has a discharge angle in the range 10 to 30 degrees above horizontal.

8. The apparatus of claim 1 or 2, further comprising:
a basin water return extending from a first end in fluid communication with said basin, through said nozzle block and said extension portion, to a second end connectable to a fountain recirculation pump intake.

9. The apparatus of claim 1 or 2, further comprising said water feature.

10. The apparatus of claim 1 or 2, further comprising:
a solenoid valve disposed between said flushing water source and said extension portion first end and controlling the flow of said flushing water; and,
a controller in control communication with said solenoid valve.
